(19) United States
(12) Patent Application Publication
(10) Pub. No.: US 2026/0252403 A1
(43) Pub. Date: Aug. 27, 2026

(54) COMPUTER-READABLE RECORDING MEDIUM HAVING STORED THEREIN INFORMATION PROCESSING PROGRAM, INFORMATION PROCESSING APPARATUS, AND INFORMATION PROCESSING METHOD

(71) Applicant: Fujitsu Limited, Kawasaki-shi (JP)

(72) Inventor: Koki KUSUNOKI, Yokohama (JP)

(73) Assignee: Fujitsu Limited, Kawasaki-shi (JP)

(21) Appl. No.: 19/543,794

(22) Filed: Feb. 18, 2026

(30) Foreign Application Priority Data
Feb. 20, 2025 (JP) 2025-026172

(51) Int. Cl. G06F 9/50; G06F 9/48

(52) U.S. Cl. CPC G06F 9/505; G06F 9/485; G06F 2209/503

(57) ABSTRACT

A non-transitory computer-readable recording medium having stored therein an information processing program that causes a computer having a plurality of calculation resources to execute a process including, when a processing target program is allocated to any of the plurality of calculation resources that are able to execute the processing target program, stopping allocating the processing target program to a first calculation resource, from among the plurality of calculation resources, that has not yet executed the processing target program in a case where a sum of an amount of context information stored in a memory of the first calculation resource and an amount of context information of the processing target program is equal to or greater than a first threshold value.

### CROSS-REFERENCE TO RELATED APPLICATION

This application is based upon and claims the benefit of priority of the prior Japanese Patent application No. 2025-026172, filed on February 20, 2025, the entire contents of which are incorporated herein by reference.

### FIELD

Embodiments relate to a computer-readable recording medium having stored therein an information processing program, an information processing apparatus, and an information processing method.

### BACKGROUND

It is known that processing performance is improved using graphics processing units (GPUs) instead of central processing units (CPUs) for executing deep learning applications (hereinafter, referred to as deep learning apps).

Since unit prices of GPUs are higher than those of CPUs, it is important to properly share and use a small number of GPUs among a plurality of programs (processes).

In addition, GPU preemption is known as an example of a method of efficiently using GPUs. In the GPU preemption, it is possible to externally stop tasks that are using GPUs and to transfer rights to use the GPUs to other tasks. By periodically performing such GPU preemption, the GPU-using tasks can be switched on a time basis, and subsequent tasks can use the GPUs without waiting for preceding tasks to be completely stopped.

For example, related arts are disclosed in Japanese Laid-open Patent Publication No. 2010-287254, US Patent No. 8253749, and Japanese Laid-open Patent Publication No. 2013-25823.

### SUMMARY

According to an aspect of the embodiments, a non-transitory computer-readable recording medium having stored therein an information processing program that causes a computer having a plurality of calculation resources to execute a process including, when a processing target program is allocated to any of the plurality of calculation resources that are able to execute the processing target program, stopping allocating the processing target program to a first calculation resource, from among the plurality of calculation resources, that has not yet executed the processing target program in a case where a sum of an amount of context information stored in a memory of the first calculation resource and an amount of context information of the processing target program is equal to or greater than a first threshold value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing system according to an embodiment;

FIG. 2 is a block diagram illustrating a hardware (HW) configuration example of a computer that implements functions of the information processing system according to an embodiment;

FIG. 3 is a diagram for explaining an information acquisition method for management parameters in the information processing system according to an embodiment;

FIG. 4 is a diagram for explaining a GPU movement possibility determination method by a scheduler unit of the

information processing system according to an embodiment;

FIG. 5 is a diagram for explaining easing conditions for GPU possibility determination by the scheduler unit of the information processing system according to an embodiment;

FIG. 6 is a flowchart for explaining an overview of GPU allocation processing in the information processing system according to an embodiment;

FIG. 7 is a flowchart for explaining an example of GPU movement possibility determination processing performed by the scheduler unit of the information processing system according to an embodiment; and

FIG. 8 is a flowchart for explaining an example of backfilling processing performed by the scheduler unit of the information processing system according to an embodiment.

### DESCRIPTION OF EMBODIMENTS

Many artificial intelligence (AI) programs reserve context information for using GPUs on memories (GPU memories) mounted on the GPUs until the programs end. The context information is, for example, information related to the programs and the GPUs. In the GPU memories, the size of the context information may be about 1 GB. Memory areas in which the context information is stored may be referred to as context memory areas.

Since the context information is deleted from the GPU memories when the programs end, the context information continues to remain on the GPU memories until the programs end. Furthermore, there is a concern that the context memory areas may increase in at least some of GPUs, which may put on a strain on the GPU memories, by the plurality of programs being executed in a multiple-GPU environment and movement of the programs being repeated among the GPUs. In a state where free spaces of the GPU memories are insufficient, execution of the programs is hindered.

Hereinafter, embodiments of the present information processing program, information processing apparatus, and information processing method will be described with reference to the drawings. However, the embodiments described below are merely examples, and it is not intended to exclude applications of various modifications and techniques that are not explicitly described in the embodiments. In other words, the present embodiments can be variously modified and implemented without departing from the gist thereof. Each drawing is not intended to mean that only the components illustrated in the drawing are included, and other functions and the like can also be included.

### A. Configuration

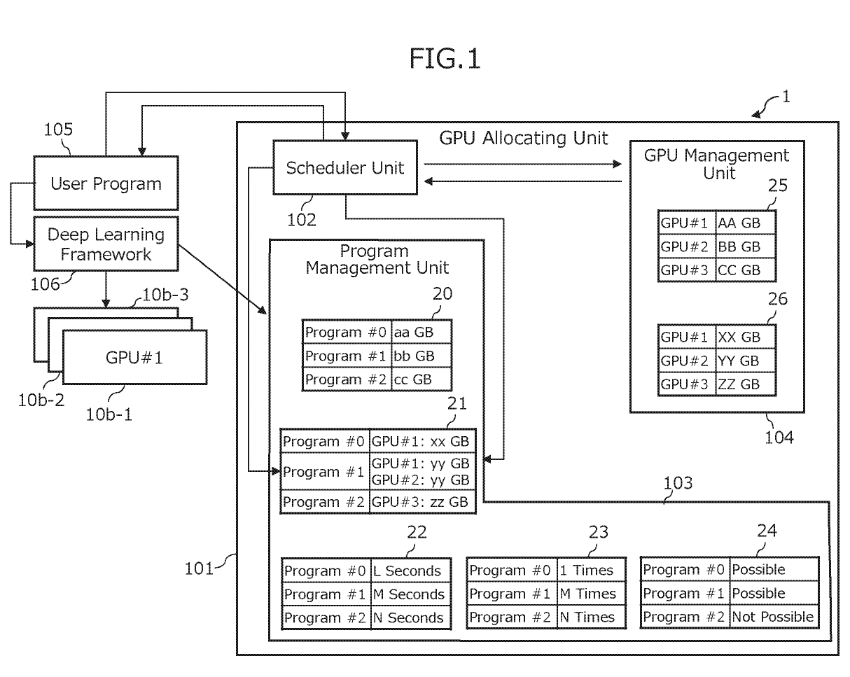

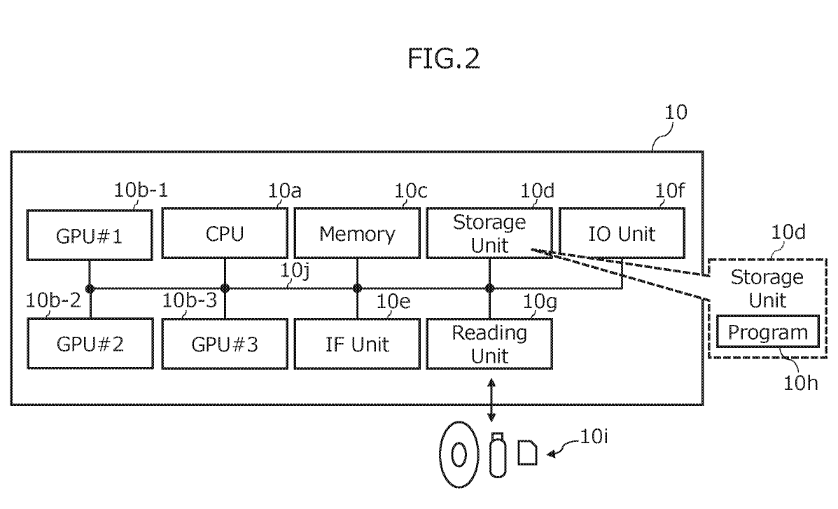

FIG. 1 is a diagram schematically illustrating a configuration of an information processing system 1 according to an embodiment, and FIG. 2 is a block diagram illustrating a hardware (HW) configuration example of a computer 10 that implements functions of the information processing system 1 according to an embodiment.

### A-1. Hardware Configuration Example

In a case where a plurality of computers is used as HW resources for implementing the functions of the information processing system 1, each computer may have the HW configuration illustrated as an example in FIG. 2.

As illustrated in FIG. 2, the computer 10 may be an information processing apparatus and may illustratively include, as the HW configuration, one or more (one in the example illustrated in FIG. 2) CPUs 10a, two or more (three in the example illustrated in FIG. 2) GPUs 10b-1 to 10b-3, a memory 10c, a storage unit 10d, an interface (IF) unit 10e, an input/output (IO) unit 10f, and a reading unit 10g. Hereinafter, the GPUs 10b-1 to 10b-3 will be referred to as GPUs 10b unless otherwise particularly distinguished.

The CPU 10a is an example of an arithmetic processing device that performs various kinds of control and calculation, and is a control unit that executes various kinds of processing. The CPU 10a may be communicably connected to each block in the computer 10 via a bus 10j.

The bus 10j may include a peripheral component interconnect-express (PCIe) bus. Note that the CPU 10a may be a multiprocessor including a plurality of processors, may be a multi-core processor including a plurality of processor cores, or may have a configuration including a plurality of multi-core processors.

The GPU 10b may be, for example, an accelerator such as a general purpose computing on graphics processing unit (GPGPU). In addition, the GPU 10b may be used to control screen display on output devices such as a monitor within the IO unit 10f. The GPU 10b may have a configuration as an accelerator that executes machine learning processing and inference processing using a machine learning model. Regarding the machine learning processing and the inference processing, it is possible to state that the GPU 10b has higher processing performance than the CPU 10a. The GPU 10b is an example of a plurality of calculation resources capable of executing assigned processing target programs. The computer 10 is an example of a computer having a plurality of calculation resources (the CPU 10a and the GPU 10b). The CPU 10a and the plurality of GPUs 10b are examples of a plurality of calculation resources.

In addition, a video random access memory (VRAM), which is not illustrated, is mounted on the GPU 10b. The VRAM of the GPU 10b may be referred to as a GPU memory. The GPU memory is an example of a second memory used by the GPU 10b (second calculation resource). The GPUs 10b–1 to 10b-3 may have the same performance, or at least some of them may have different performance. In the present embodiment, an example in which the GPUs 10b-1 to 10b-3 have the same performance will be described.

The CPU 10a and the GPUs 10b-1 to 10b-3 are calculation resources to be allocated to a user program 105, which will be described later. Furthermore, the GPU 10b-1, the GPU 10b-2, and the GPU 10b-3 may be referred to as a GPU -1, a GPU -2, and a GPU -3, respectively.

The memory 10c is an example of HW that stores information such as various kinds of data and programs. Examples of the memory 10c include one or both of a volatile memory such as a dynamic random access memory (DRAM) and a nonvolatile memory such as a persistent memory (PM). The memory 10c is an example of a first memory used by the CPU 10a. The memory 10c may be referred to as a CPU memory.

The storage unit 10d is an example of HW that stores information such as various kinds of data and programs. Examples of the storage unit 10d include various storage devices such as a magnetic disk device such as a hard disk drive (HDD), a semiconductor drive device such as a solid state drive (SSD), and a nonvolatile memory.

Examples of the nonvolatile memory include a flash memory, a storage class memory (SCM), and a read only memory (ROM).

The storage unit 10d may store a program 10h (information processing program) that implements all or some of various functions of the computer 10.

For example, the CPU 10a of the information processing system 1 implements functions as the GPU allocation unit 101 and a deep learning framework 106 by loading the program 10h stored in the storage unit 10d into the memory 10c and executing the program 10h. The functions as the GPU allocation unit 101 and the deep learning framework 106 may be referred to as scheduling functions.

The IF unit 10e is an example of a communication IF that performs control and the like of connection and communication between this computer 10 and other computers. For example, the IF unit 10e may include an adapter conforming to a local area network (LAN) such as Ethernet® or optical communication such as fiber channel (FC). The adapter may support one or both of wireless and wired communication systems. Note that the program 10h may be downloaded from a network to the computer 10 via the communication IF and may be stored in the storage unit 10d.

The IO unit 10f may include one or both of an input device and an output device. Examples of the input device include a keyboard, a mouse, and a touch panel.

Examples of the output device include a monitor, a projector, and a printer. In addition, the IO unit 10f may include a touch panel or the like in which an input device and an output device are integrated. The output device may be connected to the GPU 10b. The IO unit 10f may be an input device or an output device of another information processing apparatus remotely connected to the computer 10 by a secure shell (SSH) or the like.

The reading unit 10g is an example of a reader that reads information of data and programs recorded on the recording medium 10i. The reading unit 10g may include a connection terminal or device to which the recording medium 10i can be connected or inserted. Examples of the reading unit 10g include an adapter conforming to a universal serial bus (USB) or the like, a drive device that accesses a recording disk, and a card reader that accesses a flash memory such as an SD card. Note that the program 10h may be stored in the recording medium 10i, and the reading unit 10g may read the program 10h from the recording medium 10i and store the program 10h in the storage unit 10d.

Illustrative examples of the recording medium 10i include a non-transitory computer-readable recording medium such as a magnetic/optical disk or a flash memory. Illustrative examples of the magnetic/optical disk include a flexible disk, a compact disc (CD), a digital versatile disc (DVD), a Blu-ray disc, and a holographic versatile disc (HVD). Illustrative examples of the flash memory include semiconductor memories such as a USB memory and an SD card.

The above-described HW configuration of the computer 10 is an illustrative example. Therefore, an increase or decrease (for example, addition or deletion of arbitrary blocks), division, integration in an arbitrary combination of the HW, addition or deletion of buses, and the like in the computer 10 may be appropriately performed.

### A-2. Functional Configuration Example

As illustrated in FIG. 1, the information processing system 1 may illustratively include functions as the GPU allocation unit (GPU assigner) 101, the user program 105, and the deep learning framework 106. These functions may be implemented by hardware of the computer 10 (see FIG. 2).

The user program 105 may be, for example, a program that realizes processes of performing training (deep learning) of a deep learning model (machine learning model) and inference using the deep learning model and may execute jobs related to the deep learning. The user program 105 is, for example, a deep learning program.

In the AI processing, similar processing is repeatedly executed as seen in batch processing in learning processing and inference processing of an inference server.

For example, preprocessing, machine learning (main processing), and post-processing are repeatedly executed in the process of deep learning (training phase). Furthermore, preprocessing for reception and the like of a request, inference processing (main processing), and post-processing are similarly repeatedly executed in a process in an inference phase as well.

The CPU 10a executes processing related to allocation of the user program 105. In the processing, the CPU 10a allocates preprocessing and post-processing of the user program 105 to itself (CPU 10a), and allocates main processing of the user program 105 to the GPU 10b. Hereinafter, the processing performed by the CPU 10a executing the user program 105 is expressed as if the user program 105 is a subject, for example, “the user program 105 performs processing” for convenience.

For example, the user program 105 may output an allocation request for switching a calculation resource from the CPU 10a to the GPU 10b to the scheduler unit 102 of the GPU allocation unit 101 at the time of transition from the preprocessing to the main processing. The allocation request for switching the calculation resource from the CPU 10a to the GPU 10b may be referred to as a GPU request.

For example, the user program 105 may output an allocation request for switching the calculation resource from the GPU 10b to the CPU 10a to the scheduler unit 102 at the time of transition from the end of the main processing to the post-processing.

Note that a series of processing including the preprocessing, the main processing, and the post-processing may be referred to as a job. In the information processing system 1, one user program 105 may execute one process, or a plurality of processes may be executed by executing a plurality of user programs. One user program 105 may execute a plurality of processes. In the present embodiment, an example in which one user program 105 executes one process will be described for convenience. Hereinafter, the user program 105 may be simply referred to as a program.

In the present information processing system 1, scheduling is performed in which the calculation resources (the CPU 10a and the GPU 10b) are allocated to each of a plurality of programs and are caused to execute the programs, in the GPU allocation unit 101, which will be described later.

Furthermore, when the use of the calculation resources is ended, the user program 105 may output a calculation resource release request to the scheduler unit 102.

For example, when the processing using the GPU 10b is completed, the user program 105 transmits a GPU release notification to the scheduler unit 102. When the processing using the CPU 10a is completed, the user program 105 transmits a CPU release notification to the scheduler unit 102.

In addition, request results replied (returned) from the scheduler unit 102 in response to various requests such as a GPU allocation request, a CPU allocation request, a GPU release request, and a GPU release request transmitted to the scheduler unit 102 are input to the user program 105.

The deep learning framework 106 is a framework that performs processing related to deep learning.

The deep learning framework 106 is software that functions as a base of the user program 105 and is included so as to correspond to the user program 105. The user program 105 is executed on the deep learning framework 106. Therefore, the deep learning framework 106 may be provided for each user program 105.

The deep learning framework 106 is software serving as a base for efficiently advancing machine learning by the user program 105 and may include, for example, processing patterns that are often used by the user program 105 as a library. The deep learning framework 106 causes the GPU 10b to execute the user program 105. In other words, the deep learning framework 106 uses the GPU 10b.

Furthermore, when the GPU 10b executes the user program 105, the deep learning framework 106 measures the usage amount of the GPU memory for each GPU 10b, and transmits the measurement result to the program management unit 103 of the GPU allocation unit 101.

The deep learning framework 106 may measure the usage amount of the GPU memory in response to a request from the GPU allocation unit 101 and transmit the measurement result to the program management unit 103. The deep learning framework 106 may autonomously measure the usage amount of the GPU memory at any of various predetermined timings and transmit the measurement result to the program management unit 103.

The GPU allocation unit 101 allocates the program to the GPU 10b. As illustrated in FIG. 1, the GPU allocation unit 101 has functions as the scheduler unit 102, the program management unit 103, and the GPU management unit 104.

The GPU management unit 104 manages a state of the GPU memory of the GPU 10b. In the example illustrated in FIG. 1, the GPU management unit 104 manages the free space status of the GPU memory of each GPU 10b using the free memory management information 25. In the free memory management information 25 illustrated as an example in FIG. 1, the size of the free area of each GPU memory is associated with each of the GPUs #1 to #3.

In addition, the GPU management unit 104 manages the data size (the size of the context memory area) of the context information in the GPU memory of each GPU 10b using the context memory management information 26. In the context memory management information 26 illustrated as an example in FIG. 1, the size of the context information stored in each GPU memory is associated with each of the GPUs #1 to #3. It is possible to state that the GPU management unit 104 manages the context memory area in the GPU memory of each GPU 10b using the context memory management information 26.

For example, the GPU management unit 104 may inquire of the scheduler unit 102, which will be described later, about the size of the free area of the GPU memory of each GPU 10b and the size of the context information at a regular or irregular predetermined timing. The GPU management unit 104 registers the size of the free space of the GPU memory and the size of the context information, which are replied from the scheduler unit 102, in the free memory management information 25 and the context memory management information 26.

The program management unit 103 manages information of programs to be executed by the GPU 10b. In the example illustrated in FIG. 1, the program management unit 103 uses memory usage amount management information 20 to manage the size (memory usage amount) of the GPU memory to be used when each program is executed by the GPU 10b. The memory usage amount includes the size of the context information. In the memory usage amount management information 20 illustrated as an example in FIG. 1, each memory usage amount is associated with each of the programs #0 to #2.

In addition, the program management unit 103 uses context memory amount management information 21 to manage the data size of the context information (the size of the context memory area) of each program. The data size of the context information of each program is managed for each GPU 10b. In the context memory amount management information 21 illustrated as an example in FIG. 1, the size of the context information for each GPU 10b is associated with each of the programs #0 to #2.

Furthermore, the program management unit 103 uses execution time management information 22 to manage the execution time per iteration of each program. The execution time per iteration represents the time taken to execute each iteration (GPU execution time) when the GPU 10b is caused to execute the program. In the execution time management information 22 illustrated as an example in FIG. 1, the time taken by the GPU 10b to perform processing on one iteration is associated with each of the programs #0 to #2. Although the example in which the GPUs #1 to #3 have the same performance is described in the present embodiment, the GPU execution time may be managed for each GPU 10b in the execution time management information 22 in a case where each of the GPU #1 to #3 has different performance.

In addition, the program management unit 103 uses remaining iteration number management information 23 to manage the number of iterations (remaining iteration number) that have not yet been executed in each program. In the remaining iteration number management information 23 illustrated as an example in FIG. 1, the remaining iteration number is associated with each of the programs #0 to #2.

Furthermore, the program management unit 103 uses movement possibility management information 24 to manage possibility of movement among the GPUs for each program. Some programs are not allowed to move among the GPUs due to restrictions. For example, there is a case where a program that handles multiple GPUs is not allowed to be moved among the GPUs due to synchronization and parameter sharing. In the movement possibility management information 24 illustrated as an example in FIG. 1, information (possible/impossible) representing possibility of movement among the GPUs is associated with each of the programs #0 to #2.

For example, the program management unit 103 may inquire of the deep learning framework 106 about the memory usage amount of the user program 105, the size of the context information, the GPU execution time per iteration, the number of remaining iterations, and the like at a regular or irregular predetermined timing. The program management unit 103 registers the information replied from the deep learning framework 106 in the memory usage amount management information 20, the context memory amount management information 21, the execution time management information 22, and the remaining iteration number management information 23.

The program management unit 103 and the GPU management unit 104 acquire values for a plurality of types of management parameters on the basis of various measurement values measured by the deep learning framework 106.

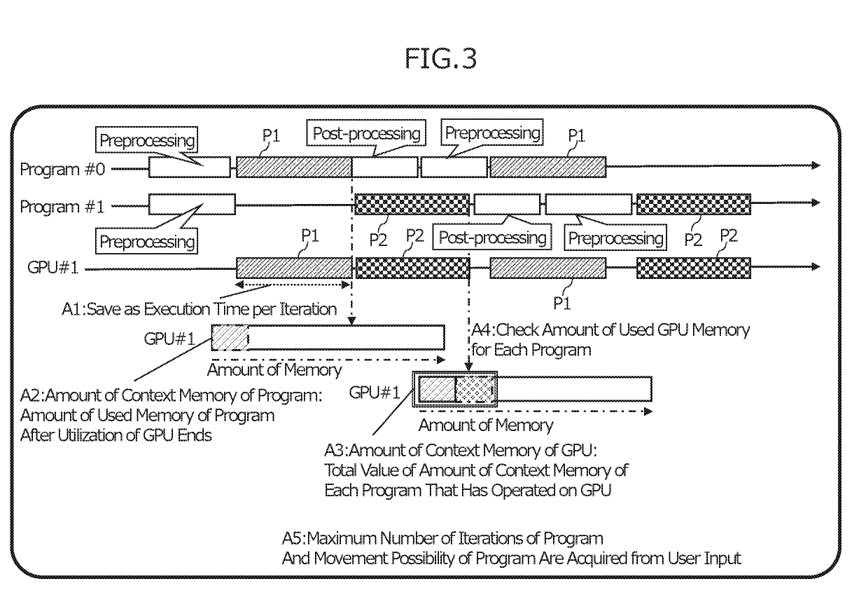

FIG. 3 is a diagram for explaining an information acquisition method for the management parameters in the information processing system 1 according to an embodiment.

FIG. 3 illustrates an example in which the GPU #1 is caused to execute main processing of the program #0 (see the reference numeral P1) and main processing of the program #1 (see the reference numeral P2). In addition, each of the main processes denoted by the reference numerals P1 and P2 in FIG. 3 represents one iteration.

The deep learning framework 106 measures the time taken to execute each iteration (GPU execution time: execution time per iteration) when the deep learning framework 106 causes the GPU 10b to execute the program (see the reference numeral A1 in FIG. 3). The measured execution time per iteration is stored in the execution time management information 22.

Furthermore, the deep learning framework 106 measures the amount of context memory of the program (see the reference numeral A2 in FIG. 3). The deep learning framework 106 measures the amount of used memory of the GPU memory after the GPU 10b first executes one iteration of the program and ends the execution (the amount of used memory of the program after the GPU 10b ends the use), and regards the measurement result as the amount of context memory of the program. The deep learning framework 106 measures the amount of context memory for each program. The measured amount of context memory of the program is stored in the context memory amount management information 21.

Furthermore, the deep learning framework 106 measures the amount of context memory of the GPU 10b (see the reference numeral A3 in FIG. 3). The deep learning framework 106 regards a total value of the amounts of context memories of one or more programs (however, programs that have not yet been ended) that have operated on the GPU 10b as the amount of context memory of the GPU 10b. The measured (calculated) amount of context memory of the GPU 10b is stored in the context memory management information 26.

Also, the deep learning framework 106 measures the amount of used GPU memory for each program (see the reference numeral A4 in FIG. 3). In addition, the user may input information indicating the maximum number of iterations of the program and the possibility of movement of the program, and the scheduler unit 102 or the like may acquire the input values (see the reference numeral A5 in FIG. 3).

The scheduler unit 102 performs scheduling for causing each GPU 10b to execute the user program 105.

The scheduler unit 102 uses a standby queue, which is not illustrated, for example, to allocate programs stored in the standby queue to the GPU 10b on the first-in first-out (FIFO) basis.

For example, when a GPU request is input from the user program 105, the scheduler unit 102 registers the program in the standby queue.

The scheduler unit 102 may refer to the free memory management information 25 managed by the GPU management unit 104 and select the GPU 10b having the free space to which the program can be allocated in the GPU memory as an allocation destination of the program. Note that in a state where all the GPUs 10b are unused, such as when the information processing system 1 is activated, all the GPUs 10b can be used as allocation destinations of the program.

When a free space occurs in any of the GPUs 10b, the scheduler unit 102 allocates the program at the head of the standby queue to the GPU 10b in which the free space has occurred.

Furthermore, the scheduler unit 102 performs control to move a program that is being executed in one GPU 10b (second calculation resource: for example, the GPU #1) among the plurality of GPUs 10b to another available GPU 10b (first calculation resource: for example, the GPU #2) and cause the GPU 10b that is the movement destination to execute the program. Accordingly, utilization efficiency of GPUs 10b can be improved.

In a case where the program (processing target program) is moved from the GPU 10b that is a movement source among the GPUs 10b and the GPU 10b that is a movement destination is caused to execute the program in this manner, the GPU 10b that is the movement source is an example of the second calculation resource, and the GPU 10b that is the movement destination is an example of the first calculation resource. Note that the movement of the program between the GPUs 10b can be realized using a known method, and the description thereof will be omitted.

In regard to the movement of the program between the GPUs 10b, the scheduler unit 102 performs control to restrict the movement of the program between the GPUs 10b and suppress an increase in amount of context memory before the amount of context memory on the GPU 10b affects the execution of the program in the GPU 10b.

In a case where the GPU 10b (used GPU 10b) that has been used in the past is not used as the movement destination of the movement target program, that is, in a case where the GPU 10b that is a movement destination candidate for the movement target program is the GPU 10b that has not been used for executing the program in the past, the scheduler unit 102 determines the possibility of movement of the program. In other words, in a case where the context information of the movement target program is not stored in the GPU 10b that is the movement destination candidate, the scheduler unit 102 determines the possibility of movement of the movement target program. The GPU 10b that is the movement destination candidate is an example of the first calculation resource.

Hereinafter, determining whether or not the program (movement target program) that is being executed on another GPU 10b can be moved to the GPU 10b that is the movement destination candidate may be referred to as GPU movement possibility determination.

In a case where the GPU 10b that is the movement destination candidate satisfies the following condition (1) in the GPU movement possibility determination, the scheduler unit 102 determines that the movement target program is allowed to be moved to the GPU 10b that is the movement destination candidate.

(The amount of context memory of the GPU + the amount of context memory of the program)

<a threshold value of the amount of context memory that allows movement...Condition (1)

In the above condition (1), the “amount of context memory of the GPU” is the amount of context memory of the GPU 10b that is the movement destination candidate, and is an example of context information stored in the memory (GPU memory) of the first calculation resource (movement destination candidate GPU 10b) that has not yet executed the processing target program from among the plurality of calculation resources (GPUs 10b).

“The amount of context memory of the program” is the amount of context memory of the movement target program and is an example of the amount of context information of the processing target program. In addition, “the threshold value of the amount of context memory that allows movement” is an example of a first threshold value.

In a case where the condition (1) is not satisfied, the scheduler unit 102 determines that it is not possible to move the movement target program to the GPU 10b that is the movement destination candidate and stops the allocation of the processing target program to the movement destination candidate GPU 10b (first calculation resource). In other words, in a case where the sum of “the amount of context memory of the GPU” and “the amount of context memory of the program” is equal to or greater than “the threshold value (first threshold value) of the amount of context memory that allows movement”, the scheduler unit 102 stops the allocation of the processing target program to the movement destination candidate GPU 10b (first calculation resource).

Note that the threshold value of the amount of context memory that allows movement may be appropriately set in accordance with applications of the system, characteristics of the program, and the like.

The scheduler unit 102 acquires the amount of context memory of the GPU 10b that is the movement destination candidate from the context memory management information 26 and acquires the amount of context memory of the movement target program from the context memory amount management information 21. The scheduler unit 102 determines whether the condition (1) is satisfied on the basis of these values.

In addition, even in a case where the fact that the movement target program is not able to be moved between the GPUs 10b is registered in the movement possibility management information 24, that is, even in a case where it is not possible to move the movement target program between the GPUs due to restrictions or the like of the program, the scheduler unit 102 determines that it is not possible to move the movement target program to the GPU 10b that is the movement target candidate and stops the allocation of the processing target program to the movement destination candidate GPU 10b (first calculation resource).

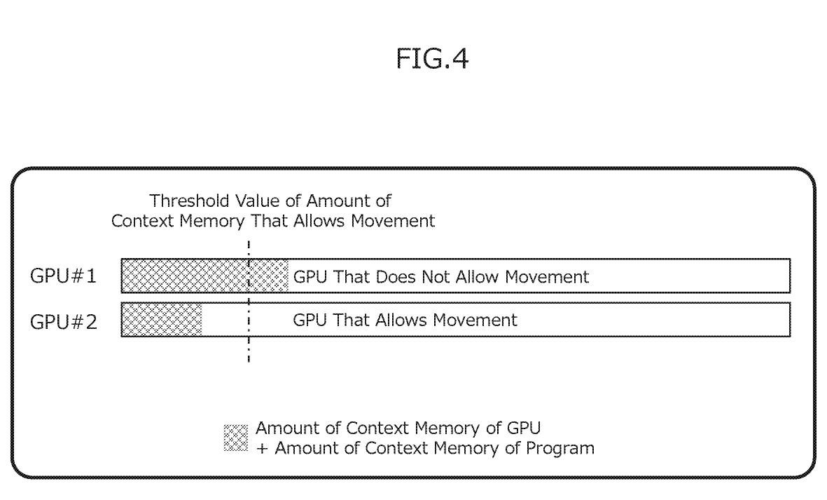

FIG. 4 is a diagram for explaining a GPU movement possibility determination method performed by the scheduler unit 102 of the information processing system 1 according to an embodiment.

In FIG. 4, the amount of context memory obtained by “the amount of context memory of the GPU + the amount of context memory of the program” is illustrated with a hatched pattern, and the threshold value of the amount of context memory that allows movement is illustrated by a one-dotted chain line, for each of the GPU #1 and the GPU #2.

In the example illustrated in FIG. 4, the value of “the amount of context memory of the GPU + the amount of context memory of the program” of the GPU #1 is equal to or greater than the threshold value of the amount of context memory that allows movement. Therefore, since the GPU #1 does not satisfy the above-described condition (1), the scheduler unit 102 determines that it is not possible to move the movement target program to the GPU #1.

On the other hand, the value of “the amount of context memory of the GPU + the amount of context memory of the program” of the GPU #2 is smaller than the threshold value of the amount of context memory that allows movement. Therefore, since the GPU #2 satisfies the above-described condition (1), the scheduler unit 102 determines that it is possible to move the movement target program to the GPU #2.

Even in a case where the above-described condition (1) is not satisfied when the GPU movement possibility determination is performed, if the following condition (2) is satisfied, and at least either the following condition (3) or (4) is satisfied, the scheduler unit 102 determines that the movement target program is allowed to be moved to the GPU 10b that is the movement destination candidate. In other words, in a case where the condition (2) is satisfied and at least either the following condition (3) or (4) is satisfied, the scheduler unit 102 eases the GPU movement possibility determination.

(The amount of context memory of the GPU + the amount of context memory of the program)

<(the amount of GPU memory - the amount of maximum memory usage of the program on the GPU)...Condition (2)

Note that in the above-described condition (2), “the amount of context memory of the GPU” is the amount of context memory of the GPU 10b that is the movement destination candidate, and “the amount of context memory of the program” is the amount of context memory of the movement target program. Also, “the amount of GPU memory” is the size of the storage area of the GPU memory. “The amount of maximum memory usage of the program on the GPU” is the maximum amount of the amount of memory used by the program that is being executed on the GPU 10b, and can be acquired from, for example, the deep learning framework 106.

The condition (2) indicates that the sum of the amount of context memory of the GPU in the case where the movement target program is moved to the GPU 10b that is the movement target candidate is less than the amount of memory in the remaining area obtained by subtracting the area used by the program from the GPU memory.

In other words, in a case where there is a free space capable of storing the context information of the processing target program in the memory (GPU memory) of the movement destination candidate GPU 10b (first calculation resource), the scheduler unit 102 eases the GPU movement possibility determination and inhibits the execution of stopping the allocation of the processing target program to the movement destination candidate GPU 10b (first calculation resource).

(Execution time per iteration of the program × the number of remaining iterations)

<(the threshold value of the execution time during which the program is allowed to be moved)...Condition (3)

The condition (3) indicates that the time taken by the movement target program to complete the remaining iterations is equal to or less than the threshold value. Note that the threshold value of the execution time during which movement is allowed may be appropriately set in accordance with the application of the system and the characteristics of the program.

In a case where the remaining execution time of the processing target program is less than a threshold value (second threshold value) of the execution time during which the program is allowed to be moved, the scheduler unit 102 eases the GPU movement possibility determination and inhibits execution of stopping the allocation of the processing target program to the movement destination candidate GPU 10b (first calculation resource).

(The number of remaining iterations of the program) < the threshold value...Condition (4)

The condition (4) indicates that the remaining iterations of the program are less than the threshold value (third threshold value). In a case where the number of remaining iterations of the processing target program is less than the third threshold value (the third threshold value = 2 in the example of the present embodiment), that is, in a case where the number of remaining iterations of the program = 1, the scheduler unit 102 eases the GPU movement possibility determination and inhibits the execution of stopping the allocation of the processing target program to the movement destination candidate GPU 10b (first calculation resource).

The conditions (3) and (4) both indicate that the remaining execution time of the movement target program is short and will end shortly. When the program ends, the context information of the program is deleted from the GPU memory. Therefore, even in a case where the above-described condition (1) is not satisfied, if any of the conditions (3) and (4) is satisfied, it means that the remaining execution time of the movement target program is short, and it is thus expected that the condition (1) will be satisfied shortly. In other words, it is expected that even if the program is moved between the GPU memories, the execution of the program is not hindered in the GPU 10b that is the movement destination.

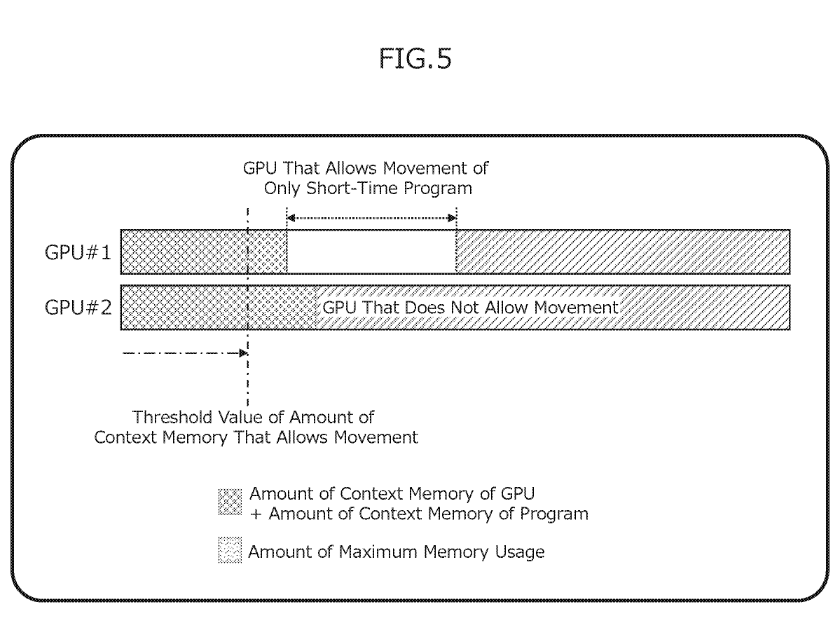

FIG. 5 is a diagram for explaining easing conditions for the GPU possibility determination by the scheduler unit 102 of the information processing system 1 according to an embodiment.

In FIG. 5, “the amount of context memory of the GPU + the amount of context memory of the program” is illustrated with a hatched pattern for each of the GPU #1 and the GPU #2. Also, “the amount of maximum memory usage of the program on the GPU” is illustrated by a striped pattern. Furthermore, the threshold value of the amount of context memory that allows movement is illustrated by a one-dotted chain line.

In the example illustrated in FIG. 5, the value of “the amount of context memory of the GPU + the amount of context memory of the program” is greater than the “threshold value of the amount of context memory that allows movement” for both of the GPUs #1 and #2. Therefore, neither the GPU #1 nor the GPU #2 satisfies the above-described condition (1) (see the hatched portion).

However, there is still a free space in the GPU memory in the GPU #1 even if the “amount of context memory of the GPU + the amount of context memory of the program” and “the amount of maximum memory usage of the program on the GPU” are subtracted from “the amount of GPU memory” (see the white portion). In other words, the above-described condition (2) is satisfied. It is considered that a program that ends in a short time can be processed in the free space of the GPU memory indicated as the white portion.

In the present information processing system 1, in a case where the condition (2) is satisfied even if the condition (1) is not satisfied, a program is allowed to be moved from another GPU 10b and executed as long as the program ends in a short time. In other words, the GPU movement possibility determination based on the condition (1) is eased.

### B. Operations

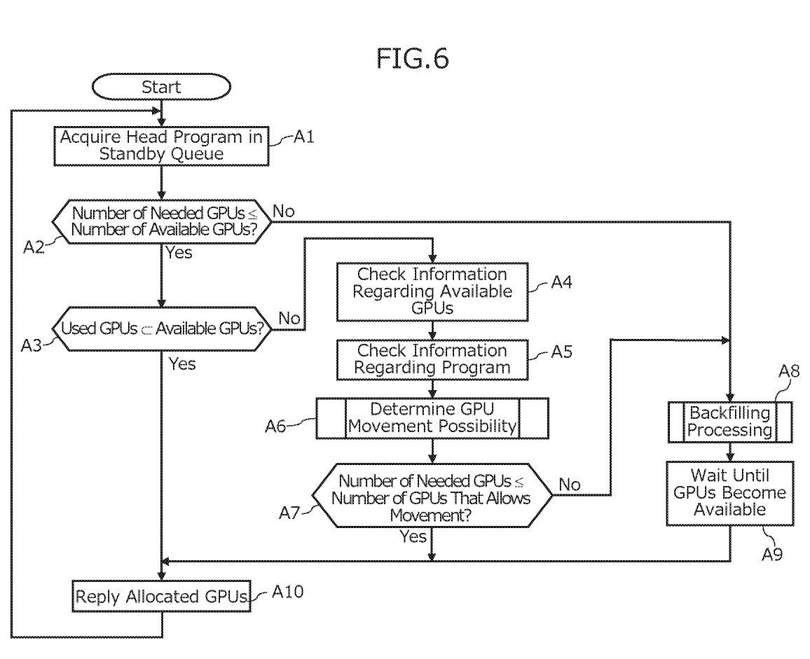

An overview of the processing of allocating the GPUs 10b in the information processing system 1 according to an embodiment configured as described above will be described in accordance with the flowchart (Steps A1 to A10) illustrated in FIG. 6.

In Step A1, the scheduler unit 102 acquires a program (target program) at the head of a standby queue.

In Step A2, the scheduler unit 102 checks whether the number of available GPUs 10b (the number of available GPUs) is equal to or greater than the number of GPUs 10b (the number of needed GPUs) that are needed for executing the target program (the number of needed GPUs ≤ the number of available GPUs).

In a case where the number of available GPUs is equal to or greater than the number of needed GPUs (see the Yes route in Step A2), the processing proceeds to Step A3. In Step A3, the scheduler unit 102 checks whether each available GPU 10b checked in Step A2 is the used GPU 10b that has been used to execute the target program (used GPU c available GPU).

In a case where the available GPU 10b is the used GPU 10b (see the Yes route in Step A3), the processing proceeds to Step A10.

In Step A10, the scheduler unit 102 responds to the user program 105 assuming that the used GPUs 10b are the GPUs 10b that are to be allocated to the target program. Thereafter, the processing returns to Step A1.

In a case where the available GPUs 10b are not the used GPUs 10b as a result of the checking in Step A3 (see the No route in Step A3), the processing proceeds to Step A4.

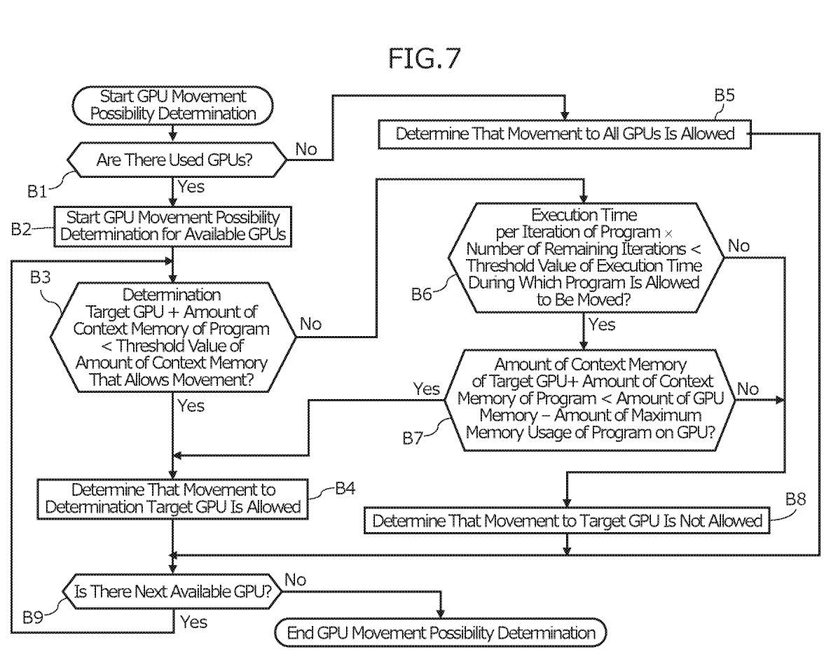

The scheduler unit 102 acquires information regarding the available GPUs 10b from the GPU management unit 104 in Step A4, and acquires information regarding the target program from the program management unit 103 in Step A5. Thereafter, in Step A6, the scheduler unit 102 performs the GPU movement possibility determination. In other words, the scheduler unit 102 determines whether the available GPUs 10b can be used as movement destinations of the program that is being executed in another GPU 10b. Details of the processing in Step A6 will be described later using the flowchart illustrated in FIG. 7.

Thereafter, in Step A7, the scheduler unit 102 checks whether the number of GPUs 10b that allow movement (the number of GPUs to which movement can be performed) is equal to or greater than the number of needed GPUs 10b (the number of needed GPUs) (the number of needed GPUs ≤ the number of GPUs that allow movement). In a case where the number of GPUs that allow movement is equal to or greater than the number of needed GPUs (see the Yes route in Step A7), the processing proceeds to Step A10. In Step A10, the scheduler unit 102 responds to the user program 105 assuming that the GPUs 10b that allow movement are the GPUs 10b to which the target program is to be allocated. Thereafter, the processing returns to Step A1.

In a case where the number of GPUs that allow movement is less than the number of needed GPUs (see the No route in Step A7) as a result of the checking in Step A7, the processing proceeds to Step A8. In a case where the number of available GPUs is less than the number of needed GPUs (see the No route in Step A2) as a result of the checking in Step A2, the processing also proceeds to Step A8.

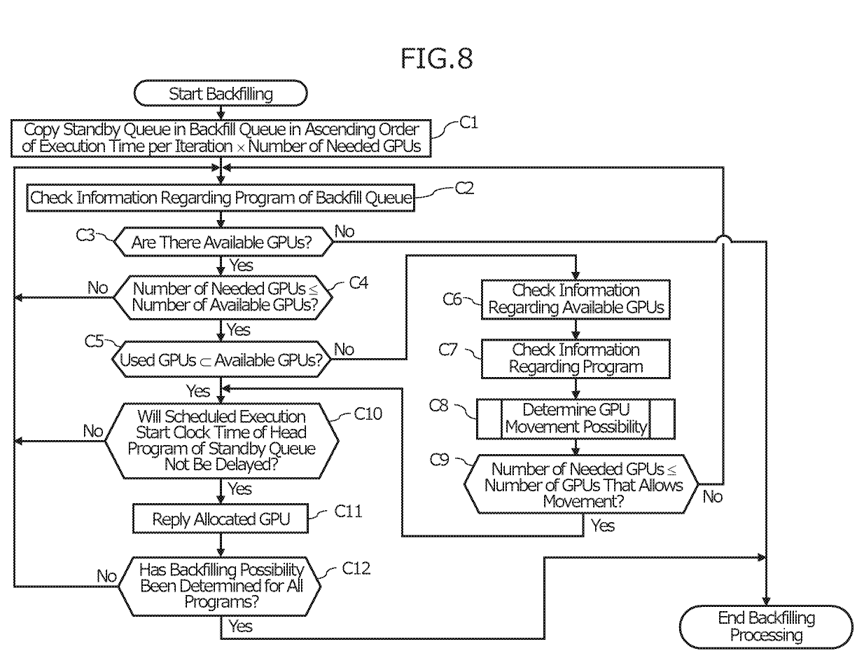

In Step A8, the scheduler unit 102 executes backfilling processing. In the backfilling processing, the GPUs 10b are allocated to another program to fill the available GPUs 10b when the head program in the standby queue waits for the needed number of GPUs 10b to be secured. Details of the processing in Step A8 will be described later using the flowchart illustrated in FIG. 8.

Thereafter, in Step A9, the scheduler unit 102 waits until the available GPUs 10b of the number that satisfies the number needed to execute the target program are generated. In a case where the available GPUs 10b of the number that satisfies the number needed to execute the target program are generated, the processing proceeds to Step A10.

In Step A10, the scheduler unit 102 responds to the user program 105 assuming that the available GPUs 10b are the GPUs 10b to be allocated to the target program. Thereafter, the processing returns to Step A1.

Next, an example of the GPU movement possibility determination processing performed by the scheduler unit 102 of the information processing system 1 according to an embodiment will be described in accordance with the flowchart (Steps B1 to B9) illustrated in FIG. 7. For this processing, details of the processing in Step A6 of the flowchart illustrated in FIG. 6 will be described.

In Step B1, the scheduler unit 102 checks whether there are GPUs 10b (used GPUs 10b) that have been used to execute the movement target program in the past among the available GPUs 10b.

In a case where there are used GPUs 10b among the available GPUs 10b (see the Yes route in Step B1), the scheduler unit 102 starts to determine GPU movement possibility for the available GPUs 10b (movement target candidate GPUs 10b) in Step B2.

In Step B3, the scheduler unit 102 checks whether the above-described condition (1) is satisfied for the determination target GPUs 10b (movement destination candidate GPUs 10b) extracted from the available GPUs 10b. In other words, the scheduler unit 102 checks whether “the amount of context memory of the determination target GPU 10b + the amount of context memory of the movement target program” is less than the threshold value of the amount of context memory that allows movement.

In a case where the condition (1) is satisfied (see the Yes route in Step B3), the scheduler unit 102 determines that the movement target program is allowed to be moved to the determination target GPU 10b in Step B4.

Thereafter, the scheduler unit 102 checks whether there is a (next) available GPU 10b for which the GPU movement possibility determination has not been performed in Step B9. In a case where there is a next available GPU 10b (see the Yes route in Step B9), the processing returns to Step B3. In a case where there is not a next available GPU 10b (see the No route in Step B9), the GPU movement possibility determination is ended. Thereafter, the processing proceeds to Step A7 in the flowchart of FIG. 6.

In a case where the condition (1) is not satisfied for the determination target GPU 10b (movement destination candidate GPU 10b) as a result of the checking in Step B3 (see the No route in Step B3), the processing proceeds to Step B6. In Step B6, the scheduler unit 102 checks whether the above-described condition (3) is satisfied for the determination target GPU 10b (movement destination candidate GPU10b). In other words, the scheduler unit 102 checks whether “the execution time per iteration of the movement target program × the number of remaining iterations” is less than the threshold value of the execution time during which the program is allowed to be moved.

In a case where the condition (3) is satisfied (see the Yes route in Step B6), the processing proceeds to Step B7. In Step B7, the scheduler unit 102 checks whether the above-described condition (2) is satisfied for the determination target GPU 10b (movement destination candidate GPU 10b). In other words, the scheduler unit 102 checks whether “the amount of context memory of the movement destination candidate GPU 10b + the amount of context memory of the movement target program” is less than “the amount of GPU memory of the movement destination candidate GPU 10b - the amount of maximum memory usage of the program executed on the movement destination candidate GPU 10b”.

In a case where the condition (2) is satisfied (see the Yes route in Step B7), the processing proceeds to Step B4. In other words, the scheduler unit 102 determines that the movement target program is allowed to be moved to the determination target GPU 10b.

In a case where the condition (3) is not satisfied in Step B6 (see the No route in Step B6), the processing proceeds to Step B8. In a case where the condition (2) is not satisfied in Step B7 (see the No route in Step B7), the processing also proceeds to Step B8.

In Step B8, the scheduler unit 102 determines that it is not possible to move the movement target program to the determination target GPU 10b. Thereafter, the processing proceeds to Step B9.

In a case where there are no used GPUs 10b among the available GPUs 10b as a result of the checking in Step B1 (see the No route in Step B1), the processing proceeds to Step B5.

In Step B5, the scheduler unit 102 determines that the movement target program is allowed to be moved to all the GPUs 10b. Thereafter, the processing proceeds to Step B9.

Note that although the scheduler unit 102 does not check whether the condition (4) is satisfied in the example illustrated in FIG. 7, the embodiment is not limited thereto. For example, the scheduler unit 102 may determine whether the condition (4) is satisfied instead of the processing in Step B6, or may determine whether the condition (4) is satisfied in addition to the processing in Step B6, and various modifications can be made.

Next, an example of the backfilling processing performed by the scheduler unit 102 of the information processing system 1 according to an embodiment will be described in accordance with the flowchart (Step C1 to C12) illustrated in FIG. 8. For this processing, details of the processing in Step A8 of the flowchart illustrated in FIG. 6 will be described.

In Step C1, the scheduler unit 102 copies programs stored in the standby queue to a backfill queue (not illustrated) in an ascending order of values of “the execution time per iteration × the number of GPUs”. As a result, the scheduler unit 102 performs the processing in Steps C2 to C8, which will be described later, on the plurality of programs stored in the standby queue from the program for which the processing will end earlier, and it is possible to reduce the amount of context memory.

In Step C2, the scheduler unit 102 checks information of the program at the head of the backfill queue. For example, the scheduler unit 102 checks the number of needed GPUs and the like of the program.

In Step C3, the scheduler unit 102 checks whether there are available GPUs 10b. In a case where there are no available GPUs 10b (see the No route in Step C3), the processing is ended. Thereafter, the processing proceeds to Step A9 in the flowchart of FIG. 6.

On the other hand, in a case where there are available GPUs 10b (see the Yes route in Step C3), the processing proceeds to Step C4. In Step C4, the scheduler unit 102 checks whether the number of available GPUs is equal to or greater than the number of GPUs 10b (the number of needed GPUs 10b) that are needed to execute the target program (the number of needed GPUs ≤ the number of available GPUs). In a case where the number of available GPUs is less than the number of needed GPUs (see the No route in Step C4), the processing returns to Step C2.

On the other hand, in a case where the number of available GPUs is equal to or greater than the number of needed GPUs (see the Yes route in Step C4), the processing proceeds to Step C5. In Step C5, the scheduler unit 102 checks whether each available GPU 10b checked in Step C3 is the used GPU 10b that has been used to execute the target program (used GPU c available GPU). In a case where there are a plurality of available GPUs 10b, whether all the available GPUs 10b are the used GPUs 10b is checked.

In a case where the available GPU 10b is not the used GPU 10b (see the No route in Step C5), the processing proceeds to Step C6.

The scheduler unit 102 acquires information regarding the available GPUs 10b from the GPU management unit 104 in Step C6, and acquires information regarding the target program from the program management unit 103 in Step C7. Thereafter, in Step C8, the scheduler unit 102 performs the GPU movement possibility determination. In other words, the scheduler unit 102 determines whether the available GPUs 10b can be used as movement destinations of the program that is being executed in another GPU 10b. Details of the processing in Step C8 are similar to those of the processing illustrated in the flowchart of FIG. 7.

Thereafter, in Step C9, the scheduler unit 102 checks whether the number of GPUs that allow movement is equal to or greater than the number of needed GPUs (the number of needed GPUs ≤ the number of GPUs that allow movement). In a case where the number of GPUs that allow movement is less than the number of needed GPUs (see the No route in Step C9), the processing returns to Step C2.

On the other hand, in a case where the number of GPUs that allow movement is equal to or greater than the number of needed GPUs (see the Yes route in Step C9), the processing proceeds to Step C10. In a case where the available GPUs 10b are the used GPUs 10b as a result of the checking in Step C5 (see the Yes route in Step C5), the processing also proceeds to Step C10.

In Step C10, the scheduler unit 102 checks whether a scheduled execution start clock time of the head program of the standby queue will not be delayed. This is to prevent the start of the processing of the head program in the standby queue from being delayed due to the backfilling processing. Since the scheduled execution start clock time of the head program of the standby queue can be carried out by a known method as a scheduler, description thereof will be omitted.

In a case where the scheduled execution start clock time of the head program in the standby queue will be delayed (see the No route in Step C10), the processing returns to Step C2.

On the other hand, in a case where the scheduled execution start time of the head program in the standby queue will not be delayed (see the Yes route in Step C10), the scheduler unit 102 responds to the user program 105 assuming that the used GPUs 10b are the GPUs 10b that are to be allocated to the target program in Step C11. Thereafter, in Step C12, the scheduler unit 102 checks whether the determination of the backfilling possibility (the processing in Steps C2 to C11) has been performed on all the programs in the backfill queue. In a case where there are programs for which the determination of the backfilling possibility has not been performed (see the No route in Step C12), the processing returns to Step C2. In a case where the backfilling possibility has been determined for all the programs in the backfill queue (the Yes route in Step C12), the processing is ended. Thereafter, the processing proceeds to Step A9 in the flowchart of FIG. 6.

### C. Effects

As described above, according to the information processing system 1 as an example of an embodiment, the scheduler unit 102 can efficiently execute a program by moving the movement target program between the GPUs 10b and causing the GPU 10b that is the movement destination to execute the program (high efficiency of the scheduling).

Furthermore, an increase in amount of context memory in the GPU memory can be suppressed, and the occurrence of an execution failure of the program and unavailability of scheduling can be suppressed, by limiting the movement of the program between the GPUs 10b.

Furthermore, in a case where the above-described condition (1) is not satisfied, the scheduler unit 102 determines that it is not possible to move the movement target program to the GPU 10b that is the movement destination candidate and stops the allocation of the processing target program to the movement destination candidate GPU 10b (first calculation resource). In this manner, it is possible to suppress an execution failure of the program by limiting the movement of the program between the GPUs 10b in the case where the condition (1) is not satisfied.

In addition, an increase in amount of context memory in the GPU 10b is suppressed by the scheduler unit 102 limiting the movement of the program between the GPUs 10b. As a result, it is possible to increase the amount of free memory in the GPU memory and to suppress an execution failure of the program due to shortage of the free memory.

Furthermore, it is possible to suppress occurrence of available GPUs 10b and to improve utilization efficiency of the GPUs 10b by the scheduler unit 102 limiting the movement of the program between the GPUs 10b.

Furthermore, it is possible to improve utilization efficiency of the GPUs 10b without increasing the amount of context memory, by performing the backfilling processing. Furthermore, it is possible to suppress an increase in amount of context memory in the GPU memory by performing the allocation by placing priority on programs that will end earlier in the backfilling processing.

Furthermore, in a case where the above-described condition (2) is satisfied and at least either the following condition (3) or (4) is satisfied, the scheduler unit 102 eases the GPU movement possibility determination. In other words, the limitation of the movement of the movement target program with a short remaining execution time, which is expected to end shortly, between the GPUs 10b is eased. Since the context information is deleted with an end of the program, it is thus possible to effectively utilize the available GPUs 10b and to improve utilization efficiency of the GPUs 10b.

The movement of the program to the GPU 10b having a large amount of context memory is disabled, and the program that has used the GPU 10b since before is executed by the backfilling processing. As a result, an increase in amount of context memory in the GPU memory of the GPU 10b can be suppressed, and the program can be stably executed in the GPU 10b.

It is possible to suppress an increase in amount of context memory in the GPU memory, to suppress influences thereof, and to realize an improvement in utilization efficiency of the GPUs 10b by combining the easing of the limitation of the movement of the program between the GPUs 10b and the backfilling processing.

### D. Others

The disclosed technology is not limited to the above-described embodiments, and various modifications can be made without departing from the gist of the present embodiments.

For example, although the above-described embodiments illustrate an example in which the calculation resources are GPUs, the embodiments are not limited thereto. The calculation resources may be processors or the like other than the GPUs.

Furthermore, according to the disclosure described above, the present embodiments can be carried out and manufactured by those skilled in the art.

According to an embodiment, it is possible to efficiently utilize the calculation resources.

Throughout the descriptions, the indefinite article "a" or "an" does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an information processing program that causes a computer having a plurality of calculation resources to execute a process comprising,
when a processing target program is allocated to any of the plurality of calculation resources that are able to execute the processing target program,
stopping allocating the processing target program to a first calculation resource, from among the plurality of calculation resources, that has not yet executed the processing target program in a case where a sum of an amount of context information stored in a memory of the first calculation resource and an amount of context information of the processing target program is equal to or greater than a first threshold value.

2. The non-transitory computer-readable recording medium according to claim 1,
wherein the computer is caused to execute inhibiting execution of the stopping in a case where a remaining execution time of the processing target program is less than a second threshold value.

3. The non-transitory computer-readable recording medium according to claim 1,
wherein the computer is caused to execute inhibiting execution of the stopping in a case where a number of remaining iterations of the processing target program is less than a third threshold value.

4. The non-transitory computer-readable recording medium according to claim 2,
wherein the computer is caused to execute,
in a case where there is a free space capable of storing context information of the processing target program in the memory of the first calculation resource,
inhibiting execution of the stopping.

5. The non-transitory computer-readable recording medium according to claim 1,
wherein the computer is caused to execute the allocating of the processing target program when the processing target program that is being executed by a second calculation resource from among the plurality of calculation resources is moved to the first calculation resource.

6. An information processing apparatus comprising:
a memory;
a processor that is connected to the memory; and
a plurality of calculation resources,
wherein the processor executes,
when a processing target program is allocated to any of the plurality of calculation resources that are able to execute the processing target program,
stopping allocating the processing target program to a first calculation resource, from among the plurality of calculation resources, that has not yet executed the processing target program in a case where a sum of an amount of context information stored in a memory of the first calculation resource and an amount of context information of the processing target program is equal to or greater than a first threshold value.

7. The information processing apparatus according to claim 6,
wherein the processor executes
inhibiting execution of the stopping in a case where a remaining execution time of the processing target program is less than a second threshold value.

8. The information processing apparatus according to claim 6,
wherein the processor executes
inhibiting execution of the stopping in a case where a number of remaining iterations of the processing target program is less than a third threshold value.

9. The information processing apparatus according to claim 7,
wherein the processor executes,
in a case where there is a free space capable of storing context information of the processing target program in the memory of the first calculation resource,
inhibiting execution of the stopping.

10. The information processing apparatus according to claim 6,
wherein the processor executes the allocating of the processing target program when the processing target program that is being executed by a second calculation resource from among the plurality of calculation resources is moved to the first calculation resource.

11. An information processing method that causes a computer having a plurality of calculation resources to execute,
when a processing target program is allocated to any of the plurality of calculation resources that are able to execute the processing target program,
stopping allocating the processing target program to a first calculation resource, from among the plurality of calculation resources, that has not yet executed the processing target program in a case where a sum of an amount of context information stored in a memory of the first calculation resource and an amount of context information of the processing target program is equal to or greater than a first threshold value.

12. The information processing method according to claim 11,
wherein the computer executes
inhibiting execution of the stopping in a case where a remaining execution time of the processing target program is less than a second threshold value.

13. The information processing method according to claim 11,
wherein the computer executes
inhibiting execution of the stopping in a case where a number of remaining iterations of the processing target program is less than a third threshold value.

14. The information processing method according to claim 12,
wherein the computer executes,
in a case where there is a free space capable of storing context information of the processing target program in the memory of the first calculation resource, inhibiting execution of the stopping.

15. The information processing method according to claim 11,
wherein the computer executes the allocating of the processing target program when the processing target program that is being executed by a second calculation resource from among the plurality of calculation resources is moved to the first calculation resource.
